(19) United States
(12) Patent Application Publication
(10) Pub. No.: US 2017/0046637 A1
(43) Pub. Date: Feb. 16, 2017

(54) METHOD OF PROVIDING ADAPTIVE TRAVEL ITINERARIES AND ELECTRONIC DEVICE IMPLEMENTING SAME

(71) Applicant: Samsung Electronics Co., Ltd., Suwon-si (KR)

(72) Inventors: Hojun JAYGARL, Hwaseong-si (KR); Dae-Sung HA, Suwon-si (KR); Jaegyu JUNG, Suwon-si (KR)

(21) Appl. No.: 15/213,940

(22) Filed: Jul. 19, 2016

(30) Foreign Application Priority Data
Aug. 10, 2015 (KR) 10-2015-0112647

(51) Int. Cl. G06Q 10/02

(52) U.S. Cl. CPC G06Q 10/025

(57) ABSTRACT

An apparatus and method for providing adaptive travel itineraries are provided. The apparatus includes an electronic device. The method includes receiving at least one piece of first itinerary information generated by an external device based on first situation information, acquiring second itinerary information generated by changing at least a part of the first itinerary information based on at least one of a user and second situation information, and providing the second itinerary information to the user.

### CROSS-REFERENCE TO RELATED APPLICATION(S)

This application claims the benefit under 35 U.S.C. §119(a) of a Korean patent application filed on Aug. 10, 2015 in the Korean Intellectual Property Office and assigned Serial number 10-2015-0112647, the entire disclosure of which is hereby incorporated by reference.

### TECHNICAL FIELD

The present disclosure relates to a method and an apparatus for providing adaptive travel itineraries.

### BACKGROUND

With the development of digital technologies, various electronic devices including mobile communication terminals, personal digital assistants (PDA), electronic organizers, smart phones, tablet personal computers (PCs), or wearable devices which can perform communication and process personal information while being carried have come to market. Electronic devices provide primary services, such as voice communication and text message transmission, but recently, electronic devices also provide a wireless Internet environment, as well as photographing, navigation, and are capable of making payments, thereby providing a wider variety of services.

That is, users can use various functions through one electronic device alone without a camera for photography, a navigation device for directions, or a credit card or cash for payment. Accordingly, the electronic device may further improve user convenience.

Due to the convenience of the electronic device, the user may acquire travel information through the electronic device when the user travels. In conventional arts, travel itineraries are generated based on preference, reviews, costs, and travel time to a travel destination. However, such a method is a static procedure performed in a travel preparation stage before travelling and has a disadvantage in which travel itineraries cannot be properly controlled according to various changes occurring during travel. Since the user directly modifies the itineraries to control the schedule according to constant changes in various situations, the user may be greatly inconvenienced. Further, if the user does not know about the travel destination, controlling the itineraries according to the situation significantly burdens the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for providing adaptive travel itineraries.

Various embodiments may provide proper alternative travel itineraries to a user by dynamically adjusting travel itineraries according to various situation changes occurring during the travel.

In accordance with an aspect of the present disclosure, a method of operating an electronic device is provided. The method includes receiving at least one piece of first itinerary information generated by an external device based on first situation information, acquiring second itinerary information generated by changing at least some a part of the first itinerary information based on at least one of a user and second situation information, and providing the second itinerary information to the user.

In accordance with another aspect of the present disclosure, an electronic device is provided. The electronic device includes a communication interface, a memory, and a processor electrically connected to the memory, wherein the processor is configured to transmit information to an external device, receive first itinerary information based on the information from the external device, change at least some of the first itinerary information based on the first situation information to generate second itinerary information, and provide the second itinerary information.

In accordance with another aspect of the present disclosure, a server is provided. The server includes a transceiver, a memory, and a processor, wherein the processor is configured to receive information from an electronic device, collect situation information, generate first itinerary information based on the information and the situation information, transmit the generated first itinerary information to the electronic device, and, when the situation information is updated, transmit the updated situation information to the electronic device.

According to various embodiments of the present disclosure, it is possible to provide proper alternative travel itineraries to a user by dynamically adjusting travel itineraries according to various changes that occur during a travel.

According to various embodiments of the present disclosure, it is possible to help the user have a highly satisfying experience with travel itineraries by automatically adjusting travel itineraries according to a real time situation.

According to various embodiments of the present disclosure, it is possible to maximize usability and availability of a travel itinerary system by providing travel itineraries suitable for a situation in real time.

According to various embodiments of the present disclosure, it is possible to identify whether travel itineraries need to be changed by comparing registered travel itineraries and situation information in real time and, when the change is needed, re-adjust the travel itineraries according to a current situation.

According to various embodiments of the present disclosure, it is possible to maximize the convenience of a user who travels, availability, and travel efficiency by re-adjusting travel itineraries in consideration of traffic situations, disaster situations, event situations, and a real time present condition of the travel destination as well as a user's change.

According to various embodiments of the present disclosure, it is possible to protect information of the electronic device without provision of information stored or registered in the electronic device to a server by downloading information request for travel itineraries to the electronic device and changing the travel itineraries by using a real time situation and the downloaded information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of cerrtain embodiments of the present disclosure will be more apparent from the following description taken in conjunction with the accompanying drawings, in which:

FIG. 1 illustrates an electronic device within a network environment according to various embodiments of the present disclosure;

FIG. 2 is a block diagram illustrating a configuration of the electronic device according to various embodiments of the present disclosure;

FIG. 3 is a block diagram of a program module according to various embodiments of the present disclosure;

FIG. 4 is a diagram illustrating a total concept for providing adaptive travel itineraries according to various embodiments of the present disclosure;

FIG. 5 illustrates a relation between an electronic device and a server according to various embodiments of the present disclosure;

FIG. 6 is a flowchart illustrating operation sequences between an electronic device and a server according to various embodiments of the present disclosure;

FIG. 7 is a flowchart illustrating an operation method of the server according to various embodiments of the present disclosure;

FIG. 8 is a flowchart illustrating an operation method of the electronic device according to various embodiments of the present disclosure;

FIG. 9 is a flowchart illustrating a method of determining situation information according to various embodiments of the present disclosure;

FIGS. 10A, 10B, 10C, and 10D illustrate an example for changing itineraries depending on situation information according to various embodiments of the present disclosure;

FIGS. 11A, 11B, 11C, 11D, 11E, 11F, 11G; and 11H illustrate a user interface of the electronic device according to various embodiments of the present disclosure; and

FIG. 12 illustrates an example for generating basic itineraries according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B. The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments of the present disclosure, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a Moving Picture Experts Group MPEG-1 audio layer-3 (MP3) player, a mobile medical device, a camera, and a wearable device. According to various embodiments of the present disclosure, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to some embodiments of the present disclosure, the electronic device may be a home appliance. The home appliance may include at least one of, for example, a television (TV), a digital versatile disc (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a MR imaging (MRI), a computed tomography (CT) machine, and an ultrasonic machine), a navigation device, a global positioning system (GPS) receiver, an event data recorder (EDR), a flight DR (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or Internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

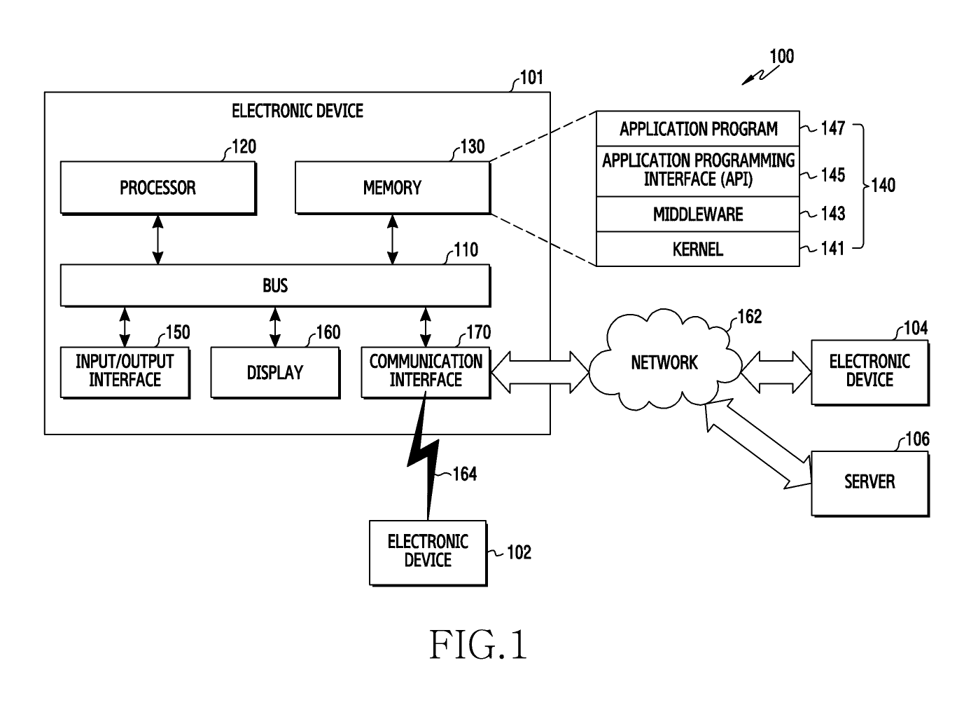

FIG. 1 illustrates a network environment including an electronic device according to various embodiments of the present disclosure.

Referring to FIG. 1, an electronic device 101 within a network environment 100, according to various embodiments of the present disclosure, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a CPU, an AP, and a communication processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a liquid crystal display (LCD), a light-emitting diode (LED) display, an organic LED (OLED) display, a microelectromechanical Systems (MEMS) display, and an electronic paper display. The display 160 may display, for example, various types of contents (e.g., text, images, videos, icons, or symbols) to users. The display 160 may include a touch screen, and may receive input, via for example, a touch, gesture, proximity, or hovering input using an electronic pen (digital pen) or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106). The wireless communication may use at least one of, for example, long term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, Wi-Fi, Bluetooth (BT), near field communication (NFC), and global navigation satellite system (GNSS). GNSS may include, for example, at least one of GPS, global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a universal serial bus (USB), a high definition multimedia interface (HDMI), recommended standard 232 (RS-232), and a plain old telephone service (POTS). The network 162 may include at least one of a telecommunication network such as a computer network (e.g., a local area network (LAN) or a wide area network (WAN)), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

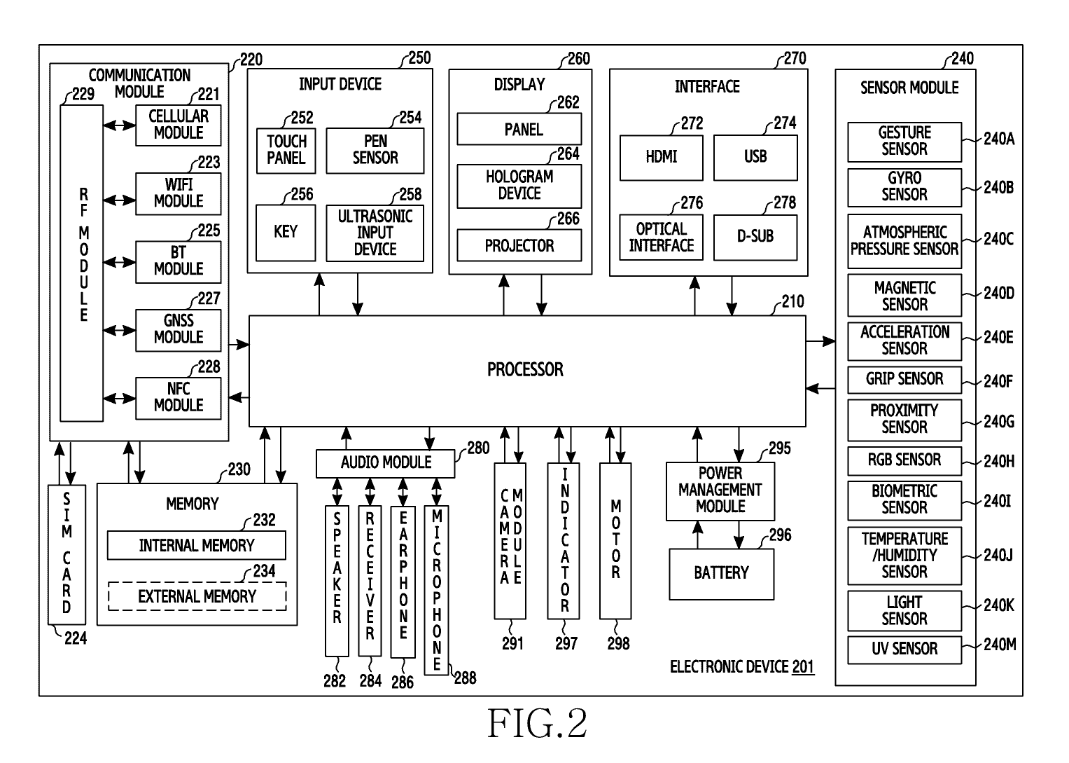

FIG. 2 is a block diagram of an electronic device according to various embodiments of the present disclosure.

Referring to FIG. 2, the electronic device 201 may include, for example, all or a part of the electronic device 101 shown in FIG. 1. The electronic device 201 may include one or more processors 210 (e.g., APs), a communication module 220, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an OS or an application program, and perform processing of various pieces of data and calculations. The processor 210 may be embodied as, for example, a system on chip (SoC). According to an embodiment of the present disclosure, the processor 210 may further include a graphic processing unit (GPU) and/or an image signal processor (ISP). The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module 227, a Glonass module, a Beidou module, or a Galileo module), an NFC module 228, and a radio frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module (SIM) (e.g., SIM card) 224 (for example, the SIM card). According to an embodiment of the present disclosure, the cellular module 221 may perform at least some of the functions that the AP 210 may provide. According to an embodiment of the present disclosure, the cellular module 221 may include a CP.

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to another embodiment of the present disclosure, at least one of the cellular module 221, the WIFI module 223, the BT module 22, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (e.g., the memory 130) may include, for example, an embedded memory 232 or an external memory 234. The embedded memory 232 may include at least one of a volatile memory (e.g., a dynamic random access memory (DRAM), a static RAM (SRAM), a synchronous DRAM (SDRAM), and the like) and a non-volatile memory (e.g., a one time programmable read only memory (OTPROM) a PROM, an erasable and programmable ROM (EPROM), an electrically EPROM (EEPROM), a mask ROM, a flash ROM, a flash memory (e.g., a NAND flash memory or a NOR flash memory), a hard disc drive, a solid state drive (SSD), and the like).

The external memory 234 may further include a flash drive, for example, a compact flash (CF), a secure digital (SD), a micro SD (Micro-SD), a mini SD (Mini-SD), an extreme digital (xD), a multimedia card (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color (RGB) sensor 240H (e.g., red, green, and blue (RGB) sensor), a biometric sensor (medical sensor) 240I, a temperature/humidity sensor 240J, an illuminance (light) sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a pen sensor (digital pen) 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The pen sensor (digital pen) 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a SD card/MMC interface, or an infrared data association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an ISP or a flash (e.g., LED or xenon lamp).

The power management module 295 may manage, for example, power of the electronic device 201. According to an embodiment of the present disclosure, the power management module 295 may include a power management integrated circuit (PMIC), a charger integrated circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as digital multimedia broadcasting (DMB), digital video broadcasting (DVB), or mediaFLO™.

Each of the above-described component elements of hardware according to the present disclosure may be configured with one or more components, and the names of the corresponding component elements may vary based on the type of electronic device. In various embodiments of the present disclosure, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

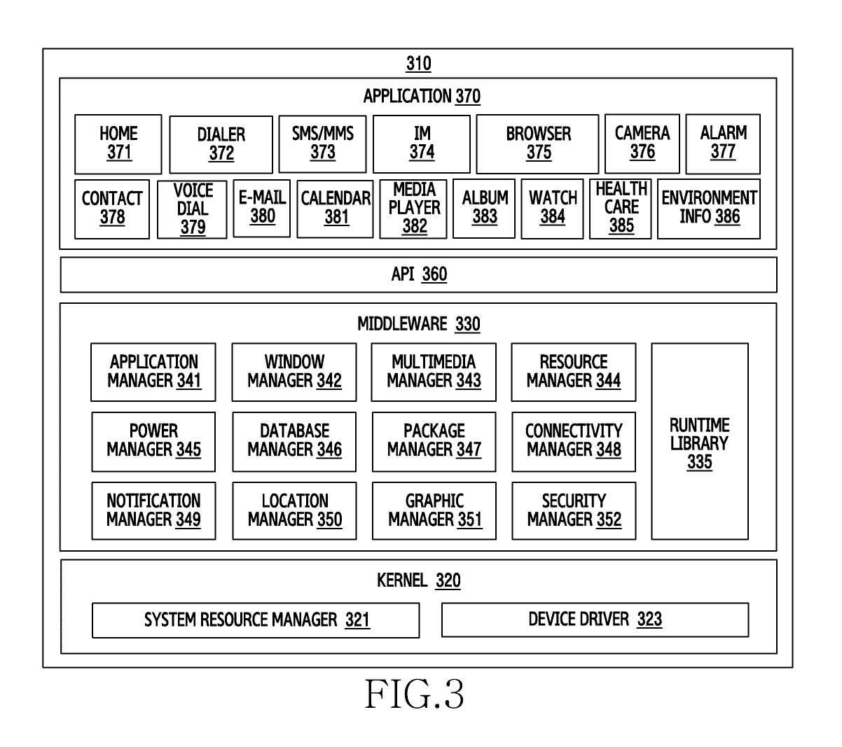

FIG. 3 is a block diagram of a program module according to various embodiments of the present disclosure.

According to an embodiment of the present disclosure, the program module 310 (e.g., the program 140) may include an OS for controlling resources related to the electronic device (e.g., the electronic device 101) and/or various applications (e.g., the application programs 147) executed in the OS. The OS may be, for example, Android™, iOS™, Windows™, Symbian™, Tizen™, Bada™, or the like.

Referring to FIG. 3, the program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a BT driver, a shared memory driver, a USB driver, a keypad driver, a Wi-Fi driver, an audio driver, or an inter-process communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 357.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage graphical user interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a basic input/output system (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or BT. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an instant message (IM) 374, a browser 375, a camera 376, an alarm 377, contacts 378, a voice dial 379, an email (E-MAIL) 380, a calendar 381, a media player 382, an album 383, a clock (WATCH) 384, health care (e.g., measuring exercise quantity or blood sugar) 385, or environment information (e.g., providing atmospheric pressure, humidity, or temperature information) 386.

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of OS.

According to various embodiments of the present disclosure, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter. According to various embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

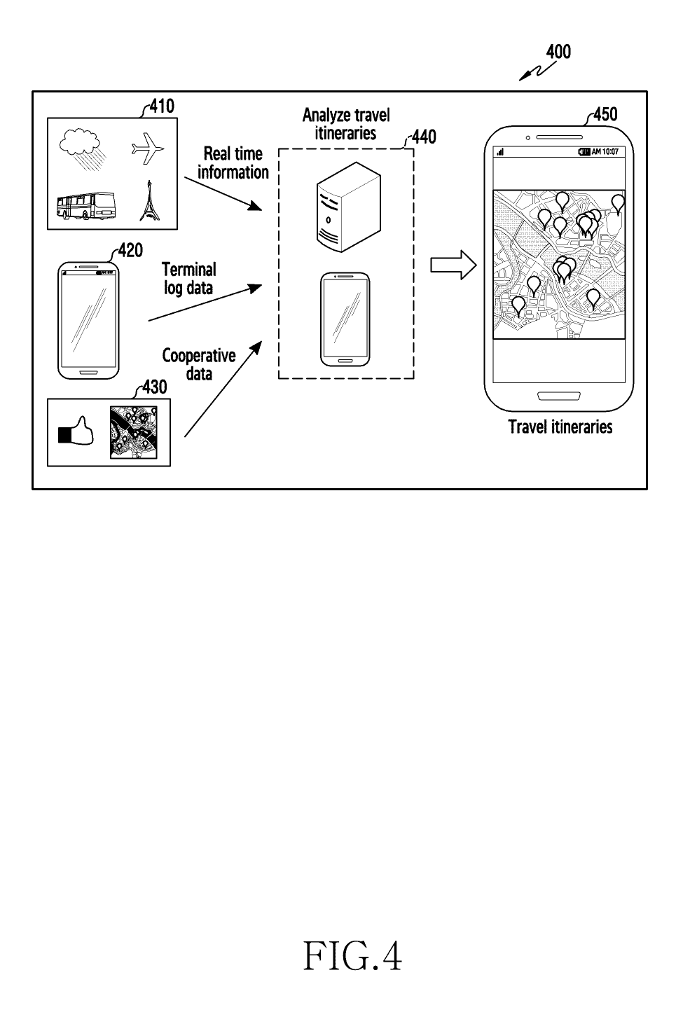

FIG. 4 is a diagram illustrating a total concept for providing adaptive travel itineraries according to various embodiments of the present disclosure.

Referring to FIG. 4, an adaptive travel itinerary provision system 400 may provide travel itineraries based on information that the user inputs before travelling and, when the user starts to travel, adjusts and proposes the travel itineraries in real time according to current situation information. The situation information may be directly recognized by the electronic device (for example, the electronic device 101 of FIG. 1 or the electronic device 201 of FIG. 2) or may be received after transmission of a request for the information to a server or an external device. Further, various pieces of meta information related to a travel destination may be collected in real time from the server or the external device and used for determining whether to adjust the travel itineraries according to the current situation. The travel itineraries may include an optimum travel route considering the line of flow of the user such as a location of the travel destination, operating hours, traffic facilities to the travel destination, restaurants near the travel destination, and recommended restaurants.

According to various embodiments of the present disclosure, the adaptive travel itinerary provision system 400 may provide optimum travel itineraries 450 by analyzing the travel itineraries as indicated by reference number 440 by using real time information 410, device (for example, the electronic device 101 of FIG. 1 or the electronic device 201 of FIG. 2) log data 420, and cooperative data 430. The real time information 410 may be situation information collected in real time and may include, for example, information on traffic, weather, and disasters (or calamities) involved in locations included in the travel itineraries. The real time information 410 may be acquired from each information provision server (for example, content provider) or acquired from one information provision server. The device log data 420 may refer to data that reflects a current location of the electronic device, a current time of the electronic device, and modifications by the user of the electronic device. For example, the modifications by the user may correspond to additions, deletions, or changes of travel destinations or restaurants included in the travel itineraries. The cooperative data 430 may recommend travel destinations or routes suitable for the user of the electronic device through a plurality of user profiles. The user profiles correspond to statistical data that analyzes travel destinations, restaurants, and routes preferred by users in the same gender, nationality, and age of the user.

The travel itinerary analysis 440 may be processed in real time in overall consideration of the real time information 410, the device log data 420, and the cooperative data 430. The travel itinerary analysis 440 may be directly performed by the electronic device or analyzed information may be acquired from the server or the external device.

The electronic device may provide the optimum travel itineraries 450 suitable for the user of the electronic device based on the travel itinerary analysis 440. The optimum travel itineraries 450 corresponds to marks of a travel route on a map and may include an optimum travel route considering the line of flow of the user such as a location of the travel destination, operating hours, traffic facilities of the travel destination, restaurants near the travel destination, and recommended restaurants. In the optimum travel itineraries 450, a location of the travel destination, public transportation use information (for example, stops, locations to get off, and a route to the travel destination after getting off), and locations of restaurants near the travel destination may be displayed on the map. When the user has difficulty in keeping an originally planned schedule, the electronic device may rapidly provide an optimum second best plan by changing and providing travel itineraries in real time according to various unexpected situations that occur during travel.

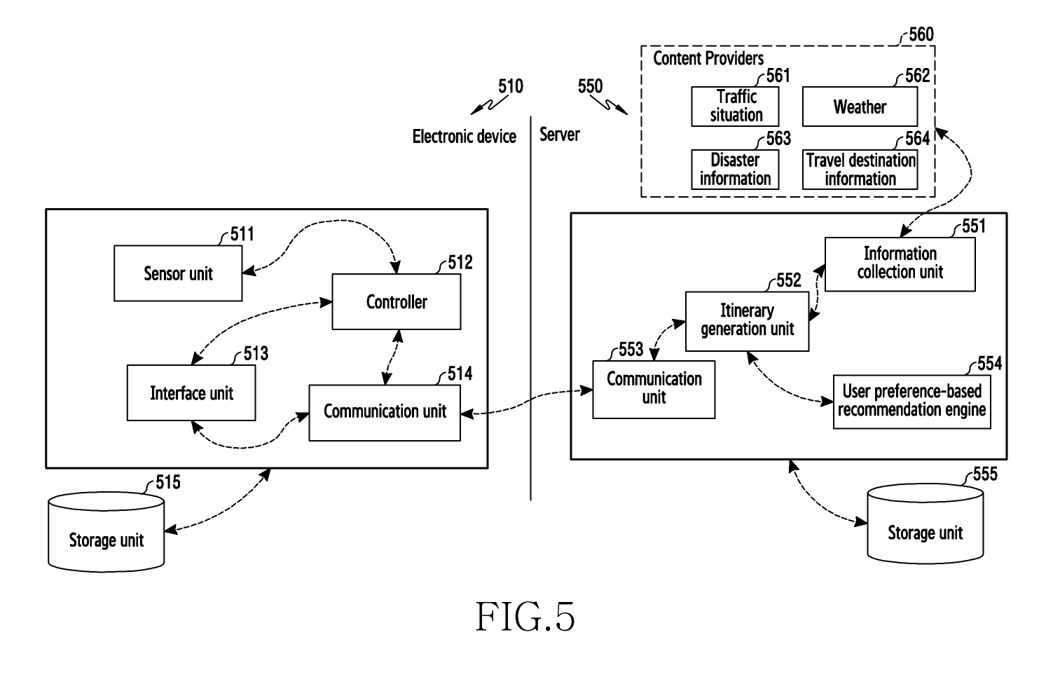

FIG. 5 illustrates a relationship between an electronic device and a server according to various embodiments of the present disclosure.

Referring to FIG. 5, an electronic device 510 may include a sensor unit 511, a controller 512, an interface unit 513, a communication unit 514, and a storage unit 515. The electronic device 510 may be the electronic device 101 of FIG. 1 or the electronic device 201 of FIG. 2.

The sensor unit 511 (for example, the sensor module 240) may collect situation information (for example, first situation information) such as a location, a user state (for example, a physical state, a motional state, fatigue, health, and emotion), circumstances (for example, temperature and humidity) based on information acquired from several sensors. According to various embodiments of the present disclosure, the sensor unit 511 may collect the situation information from a wearable device or an external device (for example, Internet of things (IoT)) connected to the electronic device 510 through a wire or wirelessly.

The controller 512 (for example, the processor 120 or the processor 210) may carry out operations or data processing relating to control and/or communication of at least one other element of the electronic device 510. The controller 512 may provide travel itineraries based on information (for example, flight, accommodations, and preferred travel destination) input by the user. The controller 512 may change the travel itineraries according to situation information. For example, the controller 512 may adjust the travel itineraries based on the travel itineraries, meta information received from a travel itinerary provision server 550, a user request, and situation information.

The interface unit 513 (for example, the input/output interface 150 or the display 160) may receive an input from the user and output (display) information according to the input. The interface unit 513 may provide a user interface that inputs information, and selects and changes travel itineraries. Further, the interface unit 513 may transfer instructions or data received from the user or another external device to another element (for example, the controller 512) of the electronic device 510 or output instructions or data received from other element(s) of the electronic device 510 to the user or the other external device.

The communication unit 514 (for example, the communication interface 170) may communicate with an external server, a cloud, and other devices located a short distance away through various communication schemes including long-range communication such as CDMA, GSM, WCDMA, and LTE and short-range communication such as Wi-Fi, BT, NFC, and UWB. The communication unit 514 may receive second situation information (for example, traffic, weather, and disaster) from an information provision server 560 (or content providers). The communication unit 514 may transmit flight and accommodation information to the travel itinerary provision server 550 and receive travel itineraries based on the information from the travel itinerary provision server 550. The communication unit 514 may receive all situation information from one information provision server 560 in real time or periodically, or receive situation information from information provision servers, respectively.

Here, the information provision server 560 may be the travel itinerary provision server 550. For example, the communication unit 514 may transmit location information of the electronic device 510 to the information provision server 560, and receive situation information related to the transmitted location information from the information provision server 560. That is, one information provision server 560 may transmit the second situation information such as traffic, weather, and disaster related to the location information to the electronic device 510. Alternatively, a traffic provision server may transmit traffic information related to the location information to the electronic device 510, a weather provision server may transmit weather information related to the location information to the electronic device 510, and a disaster provision server may transmit disaster information related to the location information to the electronic device 510.

The storage unit 515 (for example, the memory 130 or the memory 230) may store information (for example, a program or an instruction) required for operating the electronic device 510, travel itineraries, and situation information.

The travel itinerary provision server 550 may include an information collection unit 551, an itinerary generation unit 552, a communication unit 553, a user preference-based recommendation engine 554, and a storage unit 555.

The information collection unit 551 may collect situation information and travel destination information in real time or periodically. The information collection unit 551 may receive traffic situation 561, weather 562, disaster information 563, and travel destination information 564 from the information provision server 560.

The itinerary generation unit 552 may generate travel itineraries based on information input from the electronic device 510. The itinerary generation unit 552 may generate the travel itineraries by using the user preference-based recommendation engine 554. There may be one or more travel itineraries based on the flight or accommodation information. For example, the itinerary generation unit 552 may generate an itinerary and a route according to importance of the travel destination, user preference, and a traffic situation. The itinerary generation unit 552 may reflect preferred itineraries and information of other users similar to the user of the electronic device 510 through the user preference-based recommendation engine 554 to generate the travel itineraries. The itinerary generation unit 552 may change, add, or delete the generated travel itineraries according to a user's request.

The user preference-based recommendation engine 554 may analyze travel destination preferences and preferred routes of users according to user profiles according to each age, each nationality, or each gender, and select a recommended travel destination.

According to various embodiments of the present disclosure, all of the information collection unit 551, the itinerary generation unit 552, and the user preference-based recommendation engine 554 may be included in one processor.

The communication unit 553 may communicate with the electronic device 510. The communication unit 553 may receive information from the electronic device 510 and transmit travel information based on the information to the electronic device 510.

The storage unit 555 may store information (for example, a program or an instruction) required for operating the travel itinerary provision server 550, travel itineraries, and situation information.

A system according to various embodiments may include an electronic device that transmits information, receives first itinerary information based on the information, collects first situation information, changes at least some of the first itinerary information based on the first situation information to generate second itinerary information, and provides the second itinerary information, and a server that generates the first itinerary information based on the information and transmits the generated first itinerary information to the electronic device.

An electronic device according to various embodiments may include a communication interface, a memory, and a processor electrically connected to the memory, wherein the processor may be configured to transmit information to an external device, to receive first itinerary information based on the information from the external device, to change at least some of the first itinerary information based on the first situation information to generate second itinerary information, and to provide the second itinerary information.

The electronic device may further include an interface unit, wherein the processor may be configured to receive the information from a user through the interface unit or to extract the information from an application.

The information may include at least one of a flight, accommodation, user information, preferred travel destination, preferred itinerary, and travel category.

The processor may be configured to change the first itinerary information according to a request of a user and to register the changed first itinerary information.

The electronic device may further include a sensor unit, and the processor may be configured to collect first situation information by using the sensor unit or to receive second situation information from the external device.

The processor may be configured to adjust a time point when the second situation information is received based on whether a communication fee is charged and setting information of the electronic device.

The first situation information may include at least one of a time, location, temperature, humidity, and biometric information. The second situation information may include at least one of traffic, weather, disaster, and travel destination-related information.

The processor may be configured to compare the first itinerary information with the situation information, to determine whether it is required to change the itineraries based on a result of the comparison, and to generate the second itinerary information according to a result of the determination.

The processor may be configured to make a request for the second situation information to the external device according to a request of a user, setting information of the electronic device, in real time, or periodically.

The processor may be configured to determine whether the itineraries are completed and, when the itineraries are not completed, to repeatedly acquire the second itinerary information and provide the second itinerary information.

A server according to various embodiments may include a communication unit, a memory, and a processor, wherein the processor is configured to receive information from an electronic device, to collect situation information, to generate first itinerary information based on the information and the situation information, to transmit the generated first itinerary information to the electronic device, and, when the situation information is updated, to transmit the updated situation information to the electronic device.

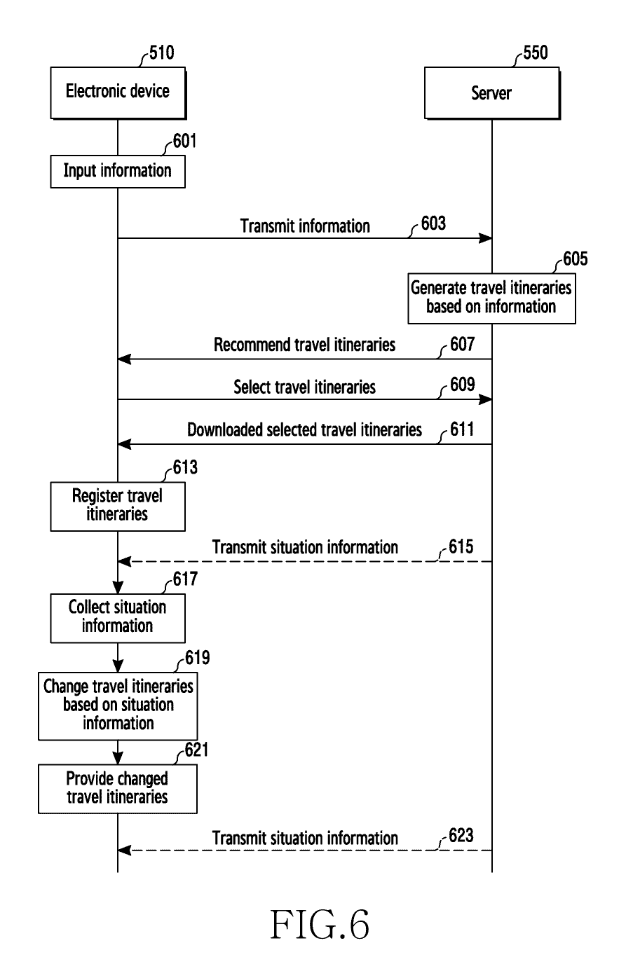

FIG. 6 is a flowchart illustrating operation sequences between the electronic device and the server according to various embodiments of the present disclosure.

Referring to FIG. 6, in operation 601, the electronic device 510 may receive information from the user. The information is required when the user makes travel itineraries, and may be about, for example, a flight (for example, depart/arrival location and time), accommodations (for example, check-in/out date and time), a preferred travel destination (for example, travel destination name or location), and a travel category (for example, tour, shopping, family, filial duty, activity, and gourmet). The electronic device 510 may directly receive the information from the user or may automatically extract the information from a message, travel, accommodation-related application. When the information is automatically extracted, the electronic device 510 may receive a selection of an application that allows the information extraction from the user. Alternatively, the electronic device 510 may determine an application which can extract information required for travel itineraries among installed applications and extract the information from the determined application.

According to an embodiment of the present disclosure, the electronic device 510 may acquire information from a plurality of installed applications and identify information required for the travel itineraries through each or a combination of the acquired information. According to an embodiment of the present disclosure, the electronic device 510 may determine the type of application which can extract the information required for the travel itineraries, download the application from the external server, and install the downloaded application.

In operation 603, the electronic device 510 may transmit the input information to the travel itinerary provision server 550. At this time, the electronic device 510 may also transmit information on the user of the electronic device 510. The user information is about the user using the electronic device 510 and may include, for example, at least one of a gender, nationality, age, and travel history. The user information may be directly input by the user or may be generated by the electronic device 510 based on a use history of the device. Further, the user information may include user information acquired through an external device (for example, server). The user information may or may not be transmitted to the travel itinerary provision server 550 according to a user's selection. In order to protect personal information of the user, the electronic device 510 may transmit only user information that does not infringe the personal information or is allowed by the user. For example, the user may allow provision of the gender and nationality only, provision of the gender and age only, or provision of the gender, nationality, age, and travel history only.

Alternatively, the electronic device 510 may also transmit information on another user who is traveling together as the user information. For example, when the user prepares a family travel with a baby and a child, the user may input gender and age of the baby and the child as the user information. Alternatively, when the user prepares a filial piety travel with parents, the user may input gender and age of the parents as the user information. Alternatively, when the user prepares a family travel with a baby and parents, the user may input gender and age of the baby and the parents as the user information.

In operation 605, the travel itinerary provision server 550 may generate travel itineraries based on the transmitted information. The travel itinerary provision server 550 may generate the travel itineraries based on the information and change the travel itineraries based on the user information. For example, the travel itinerary provision server 550 may extract travel destinations and itineraries preferred by other users of the gender, nationality, and age similar to those of the user based on user profiles corresponding to the user information and change the travel itineraries by using the extracted travel destinations and itineraries.

According to an embodiment of the present disclosure, the travel itinerary provision server 550 may change the travel itineraries by analyzing the travel destination or searching for travel destination-related information and acquiring and analyzing information on the travel destination preferred by the user through a social network service/site (SNS), email, or Internet. According to an embodiment of the present disclosure, the travel itinerary provision server 550 may search for information related to the travel destination on the Internet and identify whether a particular word determined to make a problem in the travel destination is included in the found information. When the particular word (for example, terror, disaster, heavy rain, and earthquake) is included in the found information, the travel itinerary provision server 550 may change the travel itineraries.

Alternatively, the travel itinerary provision server 550 may generate or change the travel itineraries in overall consideration of an expected traffic situation or expected weather based on a travel date. According to an embodiment of the present disclosure, when it is determined that a road is congested or a traffic situation has a problem in conducting the travel itineraries based on the analysis of the traffic situation, the travel itinerary provision server 550 may change the travel itineraries.

In operation 607, the travel itinerary provision server 550 may recommend travel itineraries. The travel itinerary provision server 550 may provide one or more generated and changed travel itineraries. For example, the number of travel itineraries may be one or more according to each user information or each travel category.

In operation 609, the electronic device 510 may receive a selection of one or more travel itineraries from the user among the recommended travel itineraries. When there is a user's request in the recommend travel itineraries, the electronic device 510 may change the travel itineraries. For example, the electronic device 510 may receive a selection of one travel itinerary from the user and add, delete, and change a travel destination, a restaurant, and a route in the selected travel itinerary according to a user's input. When the change in the travel itineraries is completed, the user may finally select one or more travel itineraries.

In operation 611, the travel itinerary provision server 550 may transmit the selected itineraries to the electronic device 510. When the travel itineraries are changed according to the user's input, the travel itinerary provision server 550 may store the changed travel itineraries to match the user information. This is to use the travel itineraries later when recommending travel itineraries to another user.

In operation 613, the electronic device 510 may register the transmitted travel itineraries. The electronic device 510 may change the travel itineraries according to a user's request before registering the transmitted travel itineraries. That is, the user may download and immediately register the travel itineraries in the electronic device 510 after the travel itinerary provision server 550 changes the travel itineraries or may download the recommended travel itineraries to the electronic device 510 from the travel itinerary provision server 550 and then change and register the travel itineraries. Once the travel starts, the electronic device 510 may provide the registered travel itineraries. The electronic device 510 may provide the travel itineraries through an application. The application may include an option item (button or key) informing of the beginning of the travel, and the user may start the travel by selecting the option item. When a travel starting item is pressed, the electronic device 510 may determine that the travel starts and display the travel itineraries.

In operation 615, the travel itinerary provision server 550 may transmit situation information to the electronic device 510. The situation information may include traffic, weather, disaster, and travel destination-related information. Although it is illustrated that the travel itinerary provision server 550 transmits the situation information to the electronic device 510 in FIG. 6, the information provision server 560 may transmit the situation information to the electronic device 510. The information provision server 560 may be singular or plural. According to an embodiment of the present disclosure, the situation information may be acquired through the Internet by the electronic device 510 by itself or may be acquired through analysis of an email or message received by the electronic device 510.

In operation 617, the electronic device 510 may collect the situation information. The situation information may be received from the server or measured by various sensors included in the electronic device 510. The electronic device 510 may collect the situation information in various ways. The electronic device 510 may collect the situation information in real time or periodically during the travel.

In operation 619, the electronic device 510 may change the travel itineraries based on the situation information. The electronic device 510 may determine whether the travel itineraries need to be changed by comparing the situation information and the travel itineraries. For example, locations of travel destinations and restaurants according to dates or time are included in the travel itineraries, and the electronic device 510 may determine that the travel itineraries need to be changed when the location of the travel destination is different from the current location. It is because conducting the original itineraries may be difficult according to traffic, weather, or the user's condition during the travel. Accordingly, the electronic device 510 may determine in real time during the travel whether the travel itineraries need to be changed and, when the change is needed, rapidly change the travel itineraries.

In operation 621, the electronic device 510 may provide the changed travel itineraries. The changed travel itineraries may be optimum itinerary B which can be next conducted as a second best plan when original itinerary A cannon be conducted.

In operation 623, the travel itinerary provision server 550 may transmit situation information to the electronic device 510. The travel itinerary provision server 550 may transmit the situation information to the electronic device 510 in real time, periodically, according to a request of the electronic device 510, or when there is an update of the situation information.

According to various embodiments of the present disclosure, when the travel itineraries start, the electronic device 510 may repeatedly perform operations 617 to 621 so as to provide an optimum second best plan when the user has difficulty in conducting the original itineraries due to an unexpected situation occurring during the travel. Accordingly, the electronic device 510 changes the travel itineraries by using the real time situation collected by the device by itself and the information received in advance from the travel itinerary provision server 550, so that the electronic device 510 may prevent the information stored or registered in the electronic device 510 from being leaked to the outside, thereby protect personal information of the user.

According to an embodiment of the present disclosure, when the electronic device 510 cannot be linked to an external server (for example, the travel itinerary provision server 550), the electronic device 510 may grasp situation information based on situation information and sensing information included in the electronic device 510 and adjust the travel itineraries.

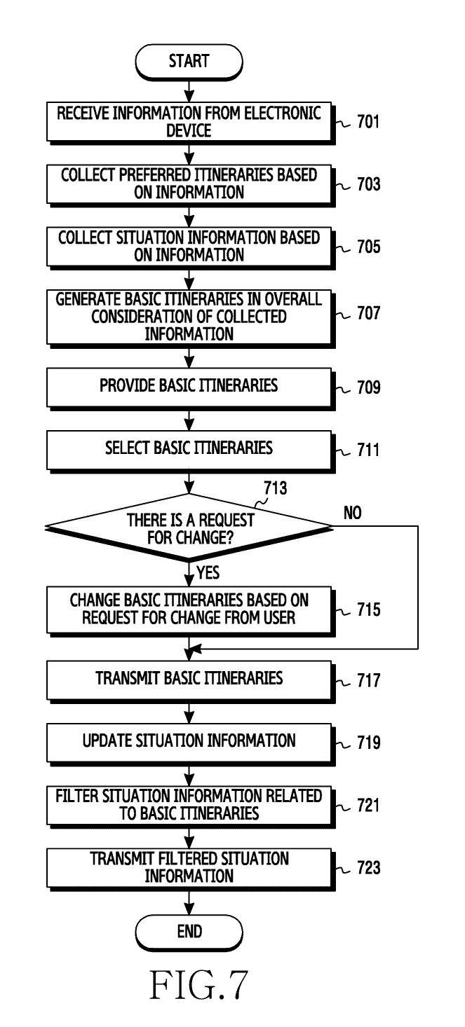

FIG. 7 is a flowchart illustrating an operation method of the server according to various embodiments of the present disclosure.

Referring to FIG. 7, in operation 701, a processor of the travel itinerary provision server 550 may receive information from the electronic device 510. The information is required when the travel itineraries are generated, and may include, for example, at least one of a flight (for example, departure/arrival location and time), accommodations (for example, check-in/out date and time), a preferred travel destination (location), a preferred itinerary (time and location), and a travel category. Alternatively, the information may include user information of the electronic device 510.

In operation 703, the processor may collect preferred itineraries based on the information. For example, the processor may extract travel destinations which can be visited based on a time for which the user stays a travel country/region and a location of accommodations, and collect preferred itineraries considering the preferred travel destinations and the preferred itineraries among the extracted travel destinations. At this time, the processor may collect travel itineraries of other users similar or equal to the user information as the preferred itineraries. The processor may preferentially extract an outdoor travel destination (for example, natural landmark) or an indoor travel destination (for example, museum) according to whether the season on the date when the user stays in the travel country/region is summer or winter. Alternatively, the processor may preferentially extract the travel destination, in which the sunrise can be viewed or the nightscape can be viewed, in consideration of the travel time.

In operation 705, the processor may collect situation information based on the information. For example, the processor may collect information on a traffic situation, weather, and disaster expected in the location included in the preferred itineraries as the situation information.

Table 1 shows the collected information.

TABLE 1

| Type | Information |
|---|---|
| Flight | destination/starting point |
| | arrival/departure date and time |
| | average time for collecting luggage and leaving airport |
| Hotel | location |
| | check-in/out date and time |
| Travel | location |
| destination | open/close time |
| | viewing time |
| | standby time (real time) |
| | identify possibility of viewing (real time) and |
| | particular event (real time) |
| | user preference (for example, religion) |
| | average parking time |
| | weather (real time) |
| | travel destination importance |
| | importance of each theme |
| | user importance |
| | visitors per year |
| | calculate weighted value according to whether |
| | corresponding traveler visits or not |
| | preference calculated by users (each age, gender, |
| | and nation) |
| Restaurant | open/close time |
| | standby time (real time) |
| | meal time |
| | parking time |
| | whether service is available (real time) |
| | break time |
| | review (taste/atmosphere) |
| Traffic | car/bicycle/public transportation |
| | considerations when estimated time of arrival is |
| | calculated (real time) |
| | clay of the week, time, weather |
| Emergency | disaster information (real time) |
| situation | situation of region included in itineraries |
| | type (heavy rain warning, terror, typhoon.) |
| | list of travel destinations prohibited |

Referring to Table 1, the collected information may include detailed information on the flight, hotel, travel destination, restaurant, traffic, and emergency. The processor may generate basic itineraries by using the information included in table 1.

In operation 707, the processor may generate the basic itineraries or travel itineraries) in overall consideration of the collected information. There may be one or more basic itineraries. For example, the number of basic itineraries may be one or more according to each user information or each travel category.

In operation 709, the processor may provide the generated basic itineraries. For example, the processor may display the basic itineraries on a webpage. The electronic device 510 may display the basic itineraries through a user interface that provides the webpage. The basic itineraries determine a travel route according to a time, and may include at least one of a location of the travel destination, a viewing time, traffic facilities to the travel destination, restaurants near the travel destination, and recommended restaurants.

In operation 711, the processor may receive a selection of the basic itineraries provided from the user. The user may select one or more basic itineraries. For example, the user may select the basic itineraries corresponding to the user information of the user and the basic itineraries corresponding to the travel category (for example, family or filial duty).

In operation 713, the processor may determine whether there is a request for changing the selected basic itineraries. An option item for adding, deleting, or changing the basic itineraries may be displayed in the user interface. The user may change the basic itineraries by selecting the option item.

When the user requests the change, the processor may change the basic itineraries based on the user's request for the change in operation 715. For example, the processor may add, delete, and change the travel destination, traffic, restaurant, and route in the selected basic itineraries according to a user's input. When the change in the basic itineraries is completed, the user may finally select one or more travel itineraries. When the basic itineraries are changed, the processor may store the changed travel itineraries to match the user information, so that the travel itineraries can be used later when the basic itineraries are recommended to another user.

In operation 717, the processor may transmit the basic itineraries to the electronic device 510. When there is no request for changing the basic itineraries in operation 713, the processor may transmit the selected basic itineraries to the electronic device 510. When there is the request for changing the basic itineraries in operation 713, the processor may transmit the changed basic itineraries to the electronic device 510. The processor may also transmit itinerary recognition meta information indicating Which weighted value (for example, itineraries considering fatigue according to an age or itineraries considering preferred food according to a region of origin) is provided to each basic itinerary to the electronic device 510 as well as the basic itineraries.

In operation 719, the processor may update situation information. The processor may collect the situation information from the information provision server 560 in real time or periodically. The processor may change or delete the existing situation information based on the situation information.

In operation 721, the processor may filter situation information related to the transmitted basic itineraries. The processor may extract only situation information such as the traffic situation, weather, and disaster expected in the travel destination included in the transmitted basic itineraries from total situation information. The filtering of the situation information may be performed based on a priority preset by the user or based on a user selection.

In operation 723, the processor may transmit the filtered situation information to the electronic device 510. At this time, the processor may transmit the filtered situation information to the electronic device 510 in real time, periodically, according to a request of the electronic device 510, or when the situation information is changed. The processor may also transmit information indicating which situation information has been changed, as meta information. According to an embodiment of the present disclosure, the processor may transmit the situation information to the electronic device 510 by the request received from the electronic device 510.

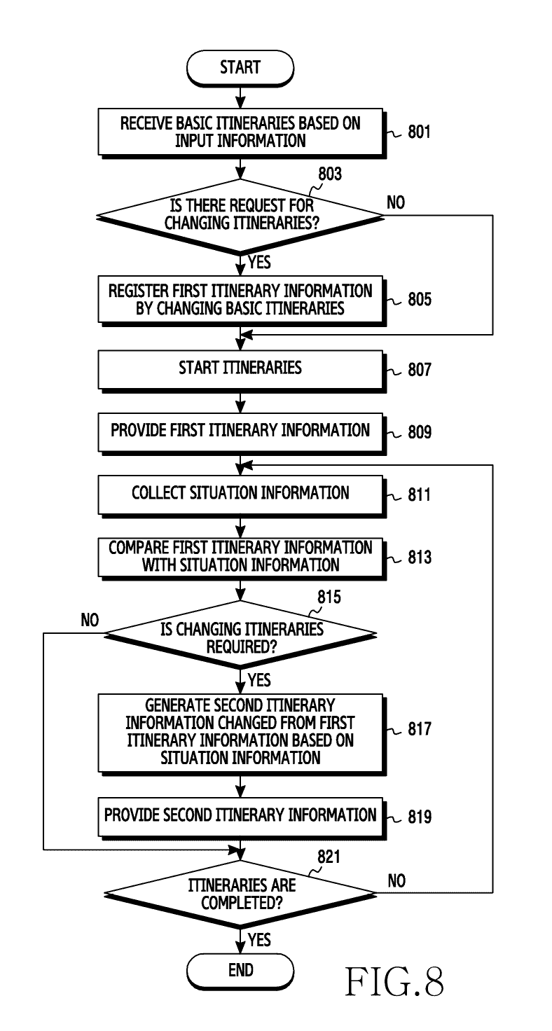

FIG. 8 is a flowchart illustrating an operation method of the electronic device according to various embodiments of the present disclosure.

Referring to FIG. 8, in operation 801, the controller 512 of the electronic device 510 may receive basic itineraries based on information input from the travel itinerary provision server 550. The controller 512 may directly receive the information from the user through the interface unit 513 or may automatically extract the information from a message, travel, accommodation-related application. When the information is automatically extracted, the controller 512 may receive a selection of an application that allows the information extraction from the user. Alternatively, the controller 512 may determine an application which can extract information required for travel itineraries among installed applications and extract the information from the determined application. The information may include at least one of a gender, nationality, age, travel category (for example, visit many tourist attraction spots, recommended restaurant, relaxation, shopping, luxury, and filial duty), flight, accommodations, traffic facility (for example, public transportation, own car, and bicycle), and life log information (for example, emotional state or health state). The controller 512 may transmit the information to the travel itinerary provision server 550 through the communication unit 514 and receive the basic itineraries generated by the travel itinerary provision server 550 based on the information.

In operation 803, the controller 512 may determine whether the user makes a request for changing the itineraries. The travel itinerary provision server 550 may change the basic itineraries before the user downloads the basic itineraries or the electronic device 510 may change the basic itineraries after the user downloads the basic itineraries. The controller 512 may display the received basic itineraries through the interface unit 513. An option item for adding, deleting, or changing the basic itineraries may be displayed in the user interface that displays the basic itineraries. The user may change the basic itineraries by selecting the option item.

When the request for changing the itineraries is made, the controller 512 may change the basic itineraries and register first itinerary information in operation 805. The itinerary change may correspond to, for example addition, deletion, or modification of the travel destination, traffic, restaurant, or route in the basic itineraries. When the request for changing the itineraries is not made, the controller 512 may register the basic itineraries as first itinerary information.

In operation 807, the controller 512 may identify whether the itineraries start. For example, the first itinerary information may be provided through an application (for example, a travel application). The user may execute the travel application to receive the first itinerary information and select “itinerary start” in the option item within the executed travel application. When the itinerary start is selected, the controller 512 may determine that the itineraries start. The user may select one of the itinerary information according to each date and select the itinerary start.

In operation 809, the controller 512 may provide the first itinerary information. The first itinerary information may include a location and travel destination information according to a time. For example, the first itinerary information may contain departing from accommodations at 9 a.m., arriving at a first location at 10:00, viewing surroundings of the travel destination, arriving at a restaurant at 12:00 for lunch, moving to a second location at 2 p.m., viewing surroundings of the travel destination, moving to a third location at 5 p.m., viewing surroundings of the travel destination, moving to a fourth location at 8 p.m., viewing a night landscape, and returning to the accommodations at 10 p.m. Accordingly, the controller 512 may provide information on the travel destination corresponding to the current time in the first itinerary information.

In operation 811, the controller 512 may collect situation information. The situation information may include first situation information collected by the electronic device 510 itself or second situation information received from the travel itinerary provision server 550 or the information provision server 560. The first situation information may include at least one of a time, location, temperature, humidity, and biometric information (for example, physical state, emotional state, fatigue, health, and emotion). The second situation information may include at least one of traffic, weather, and disaster. The controller 512 may collect the situation information in real time or periodically.

According to various embodiments of the present disclosure, the controller 512 may make a request for the second satiation information to the travel itinerary provision server 550 or the information provision server 560 according to a user's request, setting information of the electronic device 510, in real time, or periodically. Since a data information usage fee is charged when the second situation information is received, a communication fee may be charged. Accordingly, the controller 512 may make a request for the second situation information only when the communication fee does not occur. For example, when the setting information of the electronic device 510 corresponds to “always allowed”, the controller 512 may make a request for the second situation information. Alternatively, when the setting information corresponds to generation of a particular event or a user's request, the controller 512 may make a request for the second satiation information if the particular event is generated or there is the user's request. Alternatively, when the setting information corresponds to “not allowed”, the controller 512 may not make a request for the second situation information.

According to various embodiments of the present disclosure, the controller 512 may transmit a current location of the electronic device 510 when the second situation information is requested. The controller 512 may transmit the current location under an agreement of the user to protect personal information. Alternatively, the controller 512 may transmit a location which the user desires to know or information on a travel destination. For example, the user may transmit a location of a particular travel destination without transmitting the current location in order to protect personal information.

Since a data information usage fee may be charged when the second situation information is received, the controller 512 may receive the second situation information only when a communication fee does not occur (for example, in Wi-Fi communication). When the communication fee is charged, the controller 512 may not receive the second situation information. However, since the first situation information may be collected by the electronic device 510 itself, the controller 512 may collect the first situation information in real time or periodically.

In operation 813, the controller 512 may compare the first itinerary information with the situation information. The controller 512 may compare the first itinerary information with the situation information in real time, periodically, or when an emergency situation happens.

In operation 815, the controller 512 may determine whether the itineraries need to be changed based on a result of the comparison. The first itinerary information may include locations per time. When a location included in the first itinerary information is different from the current location collected as the situation information, the controller 512 may determine that the change in the first itinerary information is needed. For example, although the first itinerary information contains the arrival at the first location at 10 a.m. and viewing surroundings of the travel destination, the user may arrive at the first location at 11:30 a.m. since the user overstained the day before and thus woke up late. In this case, the user may view all the travel destinations originally planned at the first location but, if do, the user may have difficulty in conducting a next schedule. In this case, it may be required to change the itineraries to view only two travel destinations among three travel destinations originally planned at the first location and to move to the second location which correspond to the next schedule. The user may view only one travel destination among two travel destinations originally planned at the second location or may directly move to the third location corresponding to a next schedule without passing through the second location. Accordingly, the controller 512 may determine in real time during the travel whether the itineraries need to be changed and, when the change is needed, rapidly change the itineraries.

When it is determined that the itineraries need to be changed, the controller 512 may generate second itinerary information changed from the first itinerary information based on the situation information in operation 817. According to various embodiments of the present disclosure, the controller 512 may perform operation 817 under an agreement of the user. For example, when the change in the itineraries is needed while the first itinerary information within the travel application is displayed, the controller 512 may display a popup window. The popup window may be a user interface by which a confirmation of the user about whether to change the itineraries is received. The user interface may include option items such as “change itineraries”, “ok”, or “cancel” along with a phrase “do you want to change itineraries?”. When the user selects “change itineraries” in the popup window, the controller 512 may generate the second itinerary information. When the user does not select “change itineraries”, the controller 512 does not perform operations 817 and 819 and may perform operation 821.

Alternatively, the controller 512 may generate the second itinerary information based on setting information within the travel application without an agreement of the user. For example, when the itineraries are changed, the setting information may include an option item for “notification on/off”. In a case of “notification on”, the controller 512 may display the popup window. In a case of “notification off”, the controller 512 may generate the second itinerary information without a notification to the user. The second itinerary information may correspond to addition, deletion, or modification of the travel destination, traffic, restaurant, or route in the first itinerary information. The number of second itinerary information may be one or more.

In operation 819, the controller 512 may provide the second itinerary information. When the confirmation of the user about whether to change the itineraries is not received through the popup window in operation 817, the controller 512 may receive a confirmation of the user about whether to change the itineraries into the second itinerary information in operation 819. The user may select one of a plurality of second itinerary information or change the second itinerary information. The controller 512 may transmit the second itinerary information to the travel itinerary provision server 550 under an agreement of the user. The controller 512 may transmit the second itinerary information to the travel itinerary provision server 550 during the travel. Alternatively, after the itineraries are completed, the controller 512 may reflect all of the changed itinerary information and transmit the itinerary information to the travel itinerary provision server 550. The controller 512 may perform operation 821 after providing the second itinerary information.

In operation 821, the controller 512 may determine whether the itineraries have been completed. According to an embodiment of the present disclosure, the controller 512 may determine whether the itineraries have been completed when the change in the itineraries is not needed or after the second itinerary information is provided. The completion of the itineraries may be interpreted as the user completing the itineraries planned for a day and returning to the accommodations. According to an embodiment of the present disclosure, the controller 512 may determine the completion of the itineraries when the user selects “itinerary completion” within the travel application. Alternatively, the controller 512 may determine whether the current location corresponds to a location of the accommodations and, when the current location is near the accommodations, determine that the itineraries have been completed. When “itinerary completion” is not selected or the current location is not near the accommodations, the controller 512 may determine that the itineraries have not been completed and return to operation 811. In this case, by repeatedly performing operations 811 to 819, the controller 512 may continuously determine whether the itineraries need to be changed during travel and, when the itinerary change is needed, change the itineraries into an optimum second best plan and provide the changed itineraries.

An operation method of an electronic device according to various embodiments may include an operation of receiving at least one piece of first itinerary information generated by an external device based on first situation information, an operation of acquiring second itinerary information generated by changing at least some of the first itinerary information based on at least one of a user and second situation information; and an operation of providing the second itinerary information to the user.

The first situation information may include at least one piece of user information, flight information, traffic reservation information, accommodation information, and life log information.

The operation of receiving the at least one piece of first itinerary information may include an operation of receiving the first itinerary information generated through the external device based on at least one piece of travel information, location information, date information, traffic situation information, and weather information.

The operation of acquiring the second itinerary information may include an operation of comparing the first itinerary information and the second situation information, and an operation of generating the second itinerary information based on a result of the comparison.

The operation method may further include an operation of collecting the second situation information by using a sensor module included in the electronic device, or an operation of receiving the second situation information from the external device.

The second itinerary information may include itinerary information generated by adding, deleting, or changing at least one of a travel destination, traffic, restaurant, and route included in the first itinerary information.

The operation method may further include an operation of making a request for the second situation information to the external device according to a request of the user, setting information of the electronic device, in real time, or periodically.

The operation method may further include an operation of determining whether the itineraries are completed and, when the itineraries are not completed, an operation of repeatedly acquiring the second itinerary information and providing the second itinerary information.

A storage medium having instructions stored therein according to various embodiments may be a computer-readable recording medium having a program recorded therein to perform one or more operations. The instructions may be configured to perform the one or more operations by one or more processors when the instructions are executed by the one or more processors. The one or more operations may include an operation of receiving at least one piece of first itinerary information generated by an external device based on first situation information, an operation of acquiring second itinerary information generated by changing at least some of the first itinerary information based on at least one of a user and second situation information, and an operation of providing the second itinerary information to the user.

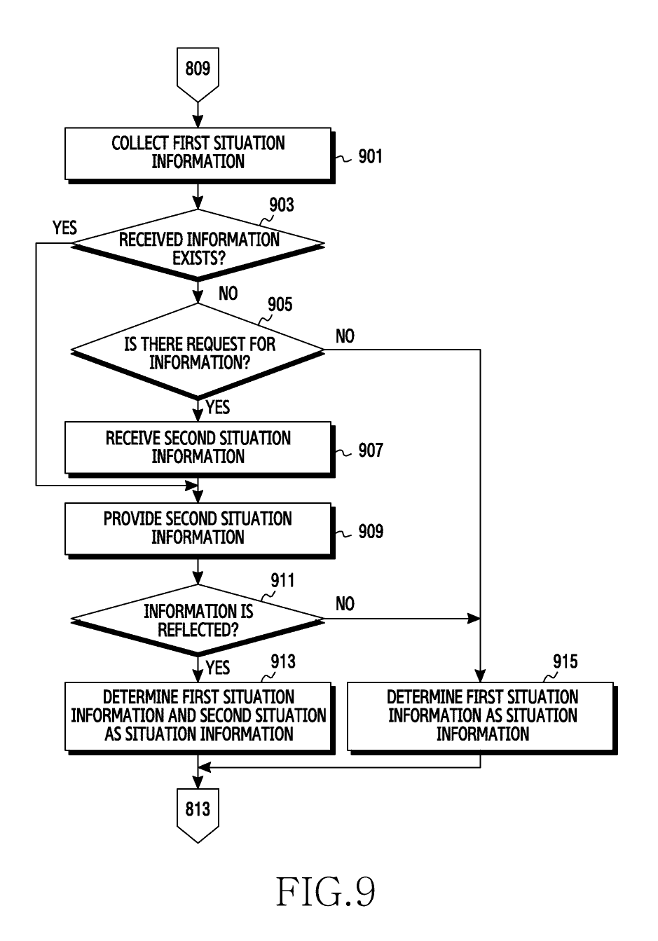

FIG. 9 is a flowchart illustrating a method of determining situation information according to various embodiments of the present disclosure. FIG. 9 describes operation 811 of FIG. 8 in detail. That is, FIG. 9 may be performed after operation 809 of FIG. 8.

Referring to FIG. 9, in operation 901, the controller 512 may collect first situation information. The first situation information is collected by the electronic device 510 itself and may include at least one of a time, location, temperature, humidity, and biometric information (for example, physical state, emotional state, fatigue, health, and emotion). According to various embodiments of the present disclosure, the controller 512 may collect the first situation information from a wearable device or an external device (for example, IoT) connected to the electronic device 510 through a wire or wirelessly.

In operation 903, the controller 512 may determine whether received second situation information exists. The second situation information may be received from the travel itinerary provision server 550 or the information provision server 560. The controller 512 may identify whether there is second situation information received before the itineraries start. The controller 512 may determine second situation information of a region included in the first itinerary information of FIG. 8 exists in the received second situation information. The controller 512 may perform operation 909 when the received second situation information exists.

When no received information exists, the controller 512 may make a request for the second situation information to the travel itinerary provision server 550 or the information provision server 560 in operation 905. According to various embodiments of the present disclosure, the controller 512 may control a time point when the second situation information is requested according to whether a communication fee occurs or according to setting information of the electronic device 510. When the second situation information is received by the request, a data information usage fee may occur, and the user may be sensitive to the communication fee. For example, the controller 512 may make a request for the second situation information at a time point (for example, Wi-Fi communication) when the communication fee does not occur. Alternatively, when there is no limitation in a data usage amount or the usage fee does not occur, the controller 512 may make a request for the second situation information in real time or periodically.

In operation 907, the controller 512 may receive the second situation information from the travel itinerary provision server 550 or the information provision server 560 which has been responded to the request. According to various embodiments of the present disclosure, the controller 512 may control a time point when the second situation information is received. For example, the controller 512 may receive the second situation information when the communication fee does not occur, and may not receive the second situation information when the communication fee does not occur. According to an embodiment of the present disclosure, the controller 512 may receive the second situation information based on a network selection by the user. For example, the user may set to not receive the situation information through a third generation (3G) or an LTE network or set to receive the situation information only through a Wi-Fi network. In this case, the controller 512 may not receive the situation information when a current network is connected to the 3G or LTE network, and may receive the situation information when the current network is connected to the Wi-Fi network. Alternatively, the opposite is possible.

In operation 909, the controller 512 may provide the received second situation information to the user. For example, the controller 512 may display the second situation information through the travel application.

In operation 911, the controller 512 may determine whether to reflect the second situation information. According to various embodiments of the present disclosure, the controller 512 may determine whether to reflect the second situation information based on a user's selection or setting information of the electronic device 510. For example, a user interface displaying the second situation information may include option items for “reflection”, “ok”, “non-reflection”, or “cancel”. The controller 512 may reflect the second situation information when the user selects “reflection” or “ok”, and may not reflect the second situation information when the user selects “non-reflection” or “cancel”. Alternatively, the controller 512 may determine whether to reflect the second situation information according to setting information of the electronic device 510 without an agreement of the user. The controller 512 may reflect the second situation information when the setting information corresponds to “always reflection”, and may not reflect the second situation information when the setting information corresponds to “non-reflection”.

When the information is reflected, the controller 512 may determine the first situation information and the second situation information as the situation information in operation 913. That is, the controller 512 may use both the first situation information collected by itself and the second situation information received from the server for changing the itineraries.

Alternatively, when the information is not reflected, the controller 512 may determine the first situation information as the situation information in operation 915. That is, the controller 512 may use only the first situation information collected by the electronic device 510 itself for changing the itineraries.

When operation 913 or operation 915 is completed, the controller 512 may perform operation 813 of FIG. 8. That is, according to various embodiments of the present disclosure, the itineraries can be changed even in a state where the network cannot be used. That is, when network cannot be used, the controller 512 may use only the first situation information collected by the electronic device 510 itself for changing the itineraries.

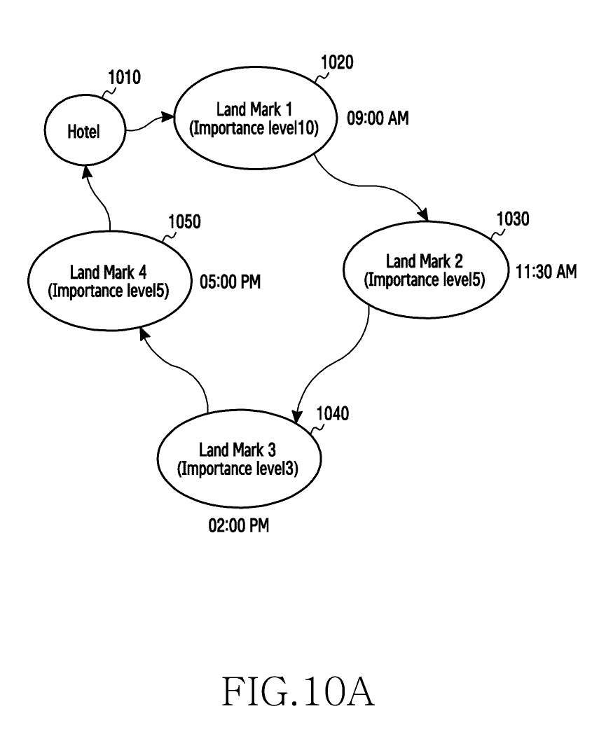

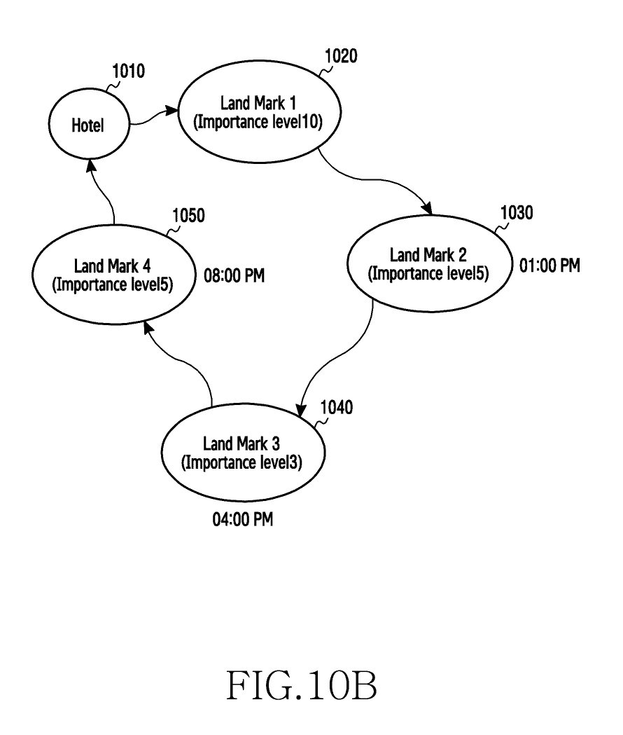

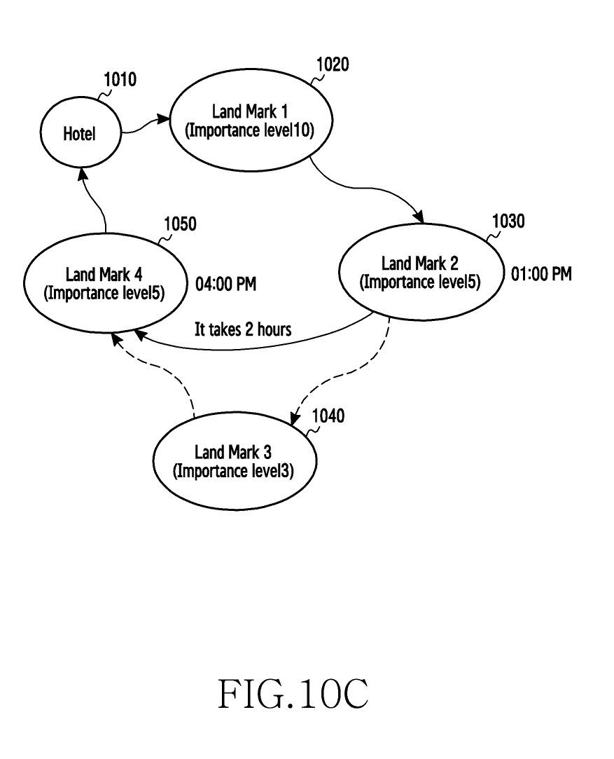

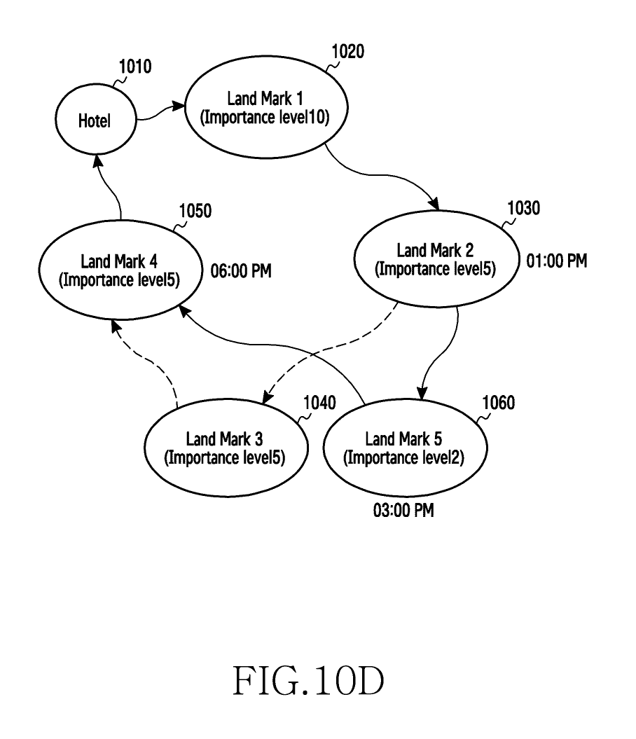

FIGS. 10A to 10D illustrate an example for changing itineraries depending on situation information according to various embodiments of the present disclosure.

FIG. 10A illustrates original itineraries (for example, first itinerary information).

Referring to FIG. 10A, the original itineraries contains departing from a hotel 1010, arriving at Land Mark1 1020 at 9 a.m., viewing Land Mark1 1020, moving to Land Mark2 1030 until 11:30 a.m., viewing Land Mark2 1030, arriving Land Mark3 1040 at 2 p.m., viewing Land Mark3 1040, arriving at Land Mark4 1050 at 5 p.m., and viewing Land Mark4 1050. A time arriving at each land mark (for example, travel destination, restaurant, or the like) may be set in consideration of a time viewing the land mark, a meal time, and a time moving to another land mark. Further, each land mark may include importance.

According to various embodiments of the present disclosure, the importance may include a theme-specific importance or a user importance. The theme-specific importance of the travel destination may have a different level of importance according to the themes in spite of the same travel destination. For example, with respect to land mark1, an importance level for delicious food may be 5, an importance level for a view point may be 3, and an importance level for comfort may be 4. Further, the user importance may include the levels of importance of the user of the electronic device 510 or other users accompanying the user.

FIG. 10B illustrates actual itineraries. Referring to FIG. 10B, the time when the user arrives at Land Mark2 1030 in the original itineraries is 11:30 a.m., but the user arrives at Land Mark2 1030 at 1:00 p.m. in the actual itineraries, the time when the user arrives at Land Mark3 1040 in the original itineraries is 2:00 p.m., but the user arrives Land Mark3 1040 at 4:00 p.m. in the actual itineraries, and the time when the user arrives at Land Mark4 1050 is 5:00 p.m. in the original itineraries, but the user arrives at Land Mark4 1050 at 8:00 p.m. in the actual itineraries. This is because the user leaves the hotel 1010 late and the time when the user arrives at Land Mark1 1020 is delayed, and thus the time when the user arrives at Land Mark2 1030, Land Mark3 1040, and Land Mark4 1050 may be sequentially delayed. Alternatively, it is because the user takes too much time to buy a ticket for Land Mark1 1020 and thus the time when the user arrives at Land Mark2 1030, Land Mark3 1040, and Land Mark4 1050 may be sequentially delayed. Alternatively, it is because the user may spend two hours to move from Land Mark1 1020 to Land Mark2 1030 although the user originally expected one hour.

That is, so many conditions act as variables during real travel, so that the user may have difficulty in conducting the originally planned itineraries. In this case, according to various embodiments of the present disclosure, the electronic device 510 may reflect various pieces of situation information during the travel in real time to automatically change the itineraries, thereby improving user convenience.

FIG. 10C illustrates changed itineraries for example, second itinerary information). Referring to FIG. 10C, the time when the user arrives at Land Mark2 1030 is 11:30 a.m. in the original itineraries, but the user may arrive at Land Mark2 1030 at 1:00 p.m. in the actual itineraries, in this case, the controller 512 may change the itineraries to directly move to Land Mark4 1050 from Land Mark2 1030 without visiting Land Mark3 1040 included in the original itineraries. When the user directly moves to Land Mark4 1050 without passing through Land Mark3 1040, the arrival at Land Mark4 1050 is scheduled at 5:00 p.m. in the original itineraries, but the user may arrive at Land Mark4 1050 at 4:00 p.m. That is, the controller 512 may change the itineraries in overall consideration of the importance of each land mark, current time, current location, biometric information, traffic, and weather,

FIG. 10D illustrates other changed itineraries (for example, second itinerary information). Referring to FIG. 10D, the controller 512 may change the itineraries to move to Land Mark5 1060 and then move to Land Mark4 1050 from Land Mark5 1060 without visiting Land Mark3 1040 included in the original itineraries. In this case, even though the user arrives at Land Mark2 1030 at 1:00 p.m. which is later than originally planned, the controller 512 may change the itineraries to allow the user to arrive at other land marks not much later than originally planned. That is, the user may arrive at Land Mark5 1060 at 3:00 p.m. and at Land Mark4 1050 at 6:00 p.m. in the changed itineraries.

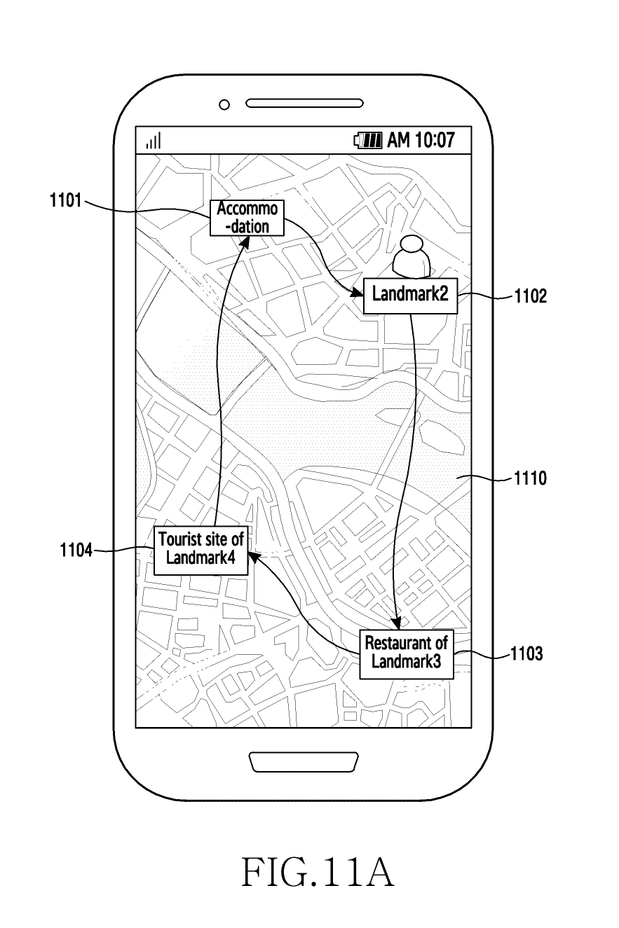

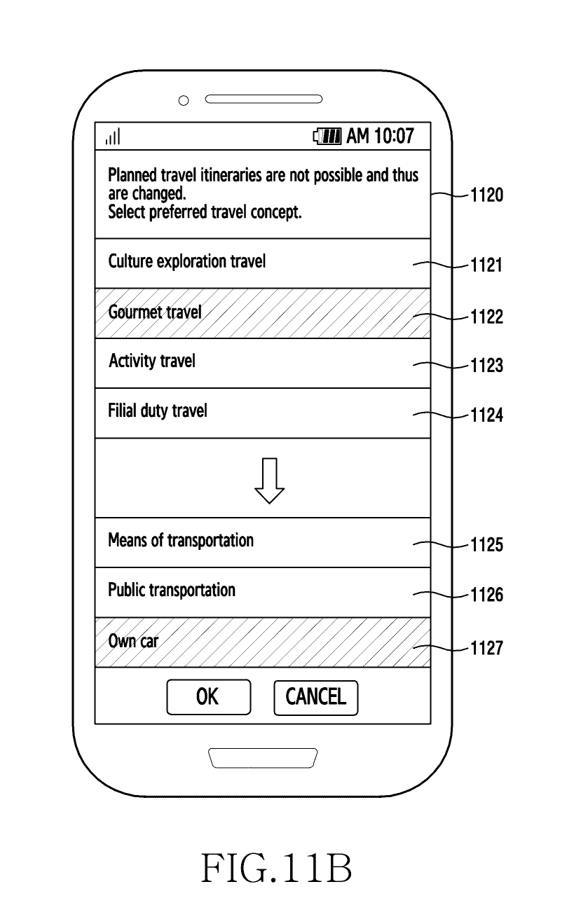

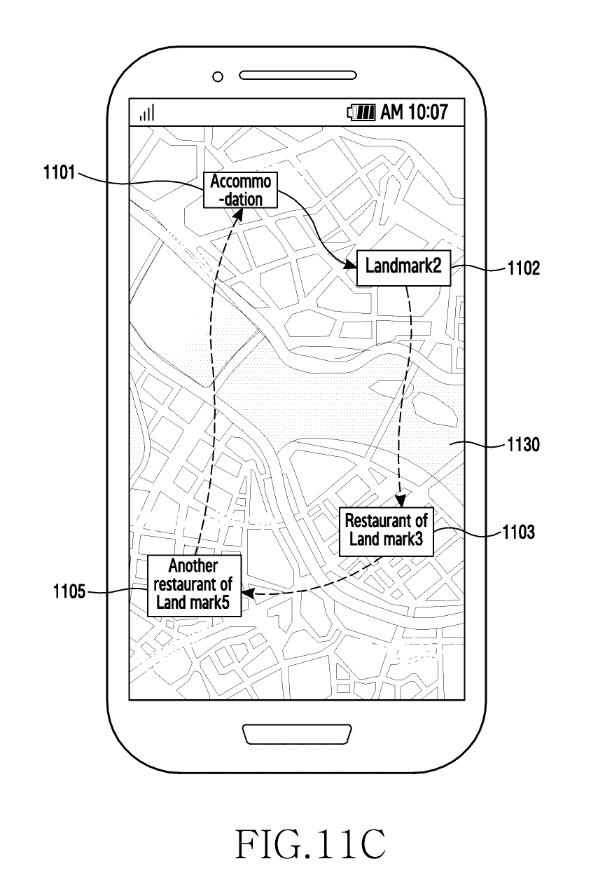

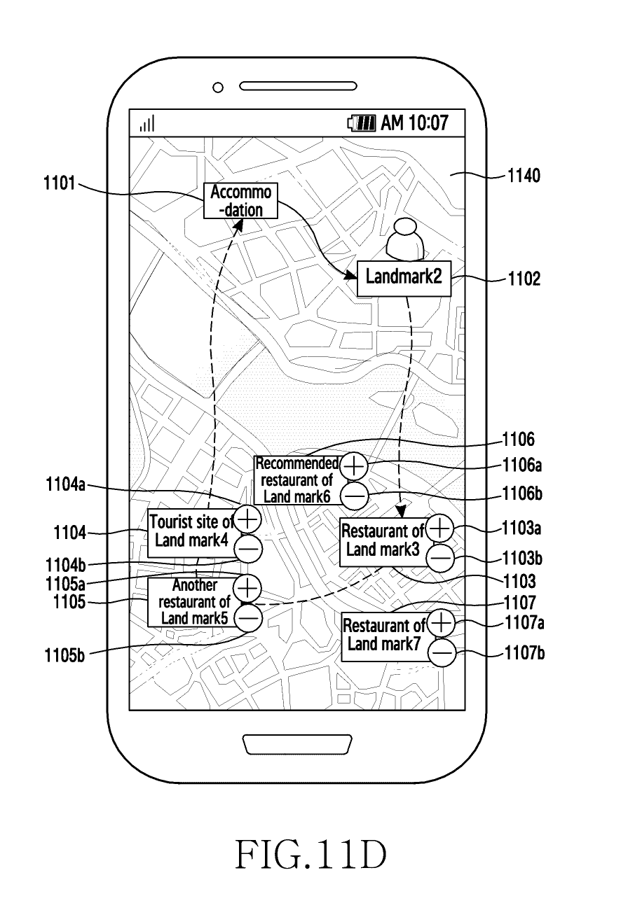

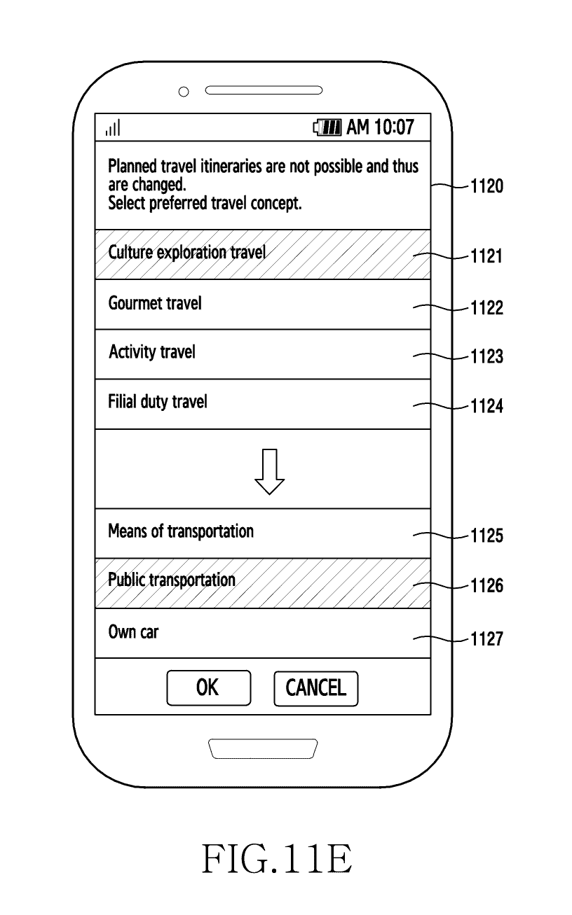

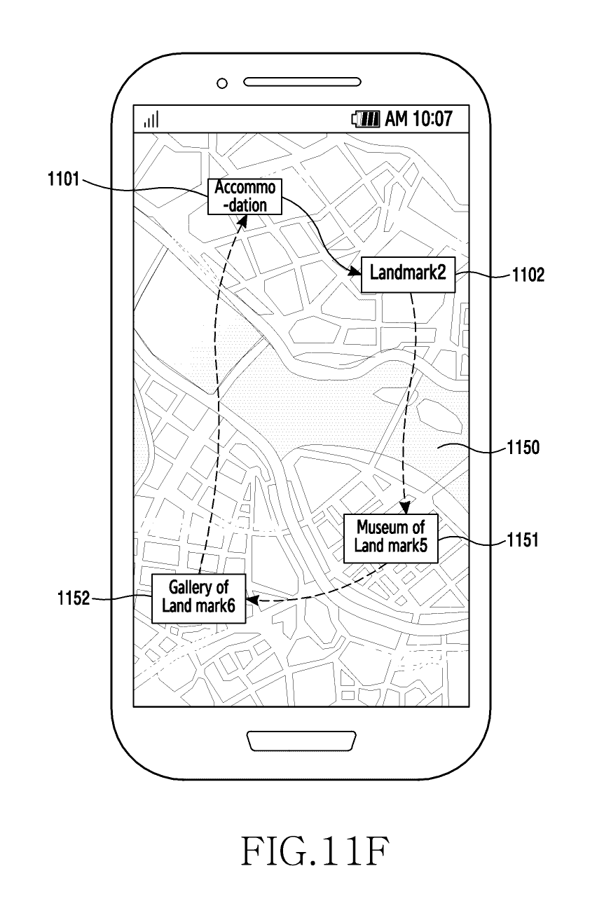

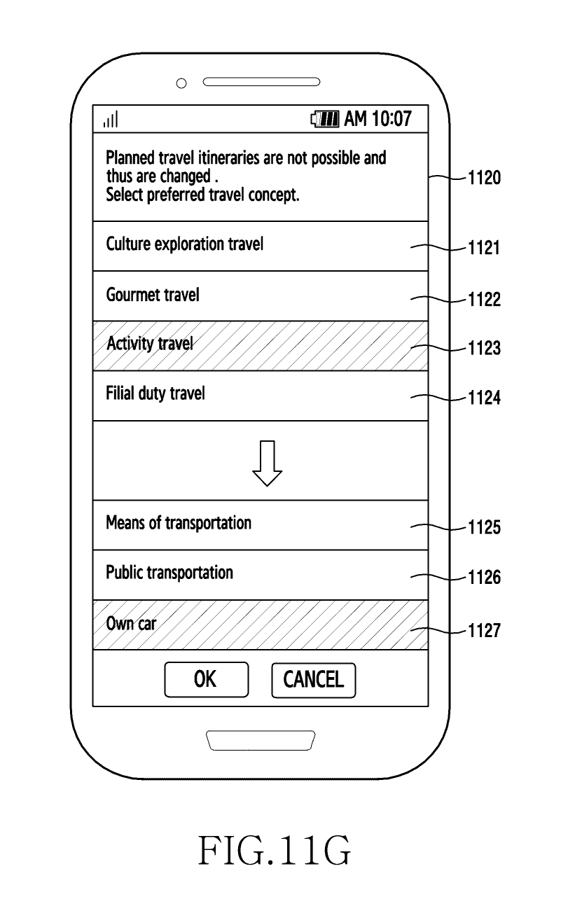

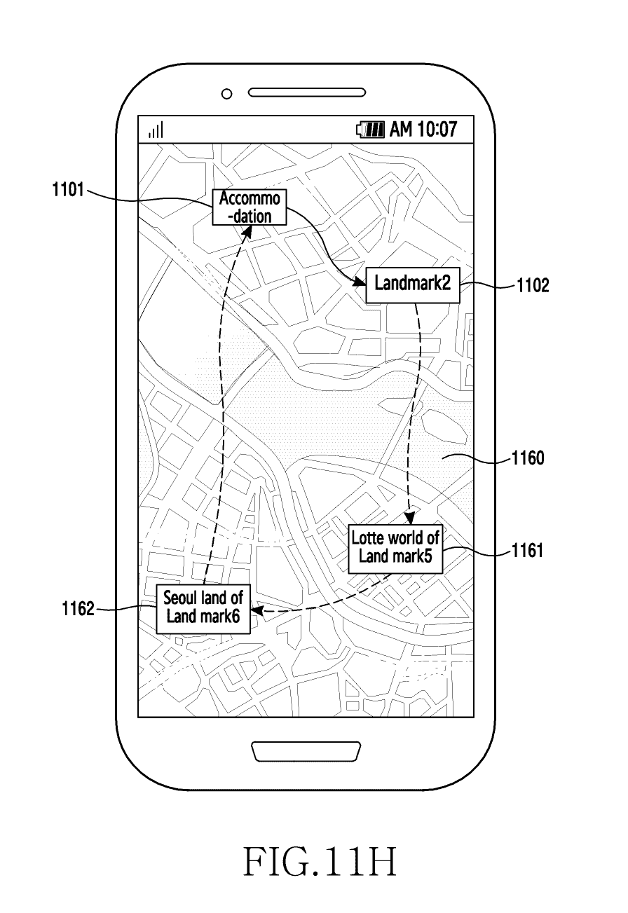

FIGS. 11A to 11H illustrate a user interface of the electronic device (e.g., the electronic device 101, 201, or 510) according to various embodiments of the present disclosure.

FIG. 11A illustrates basic itineraries.

Referring to FIG. 11A, the controller 512 may display a user interface screen 1110 including the basic itineraries. The user interface screen 1110 may display a map image on which accommodation 1101, Land Mark2 1102, a restaurant of Land Mark3 1103, and a tourist site of Land Mark4 1104 are marked at corresponding locations.

FIG. 11B illustrates a user interface for changing basic itineraries.

Referring to FIG. 11B, the controller 512 may display a user interface screen 1120 for changing the basic itineraries. The user interface screen 1120 may include option items for changing a travel category or changing a means of transportation 1125. For example, the travel category may include a culture exploration travel 1121, a gourmet travel 1122, an activity travel 1123, and a filial duty travel 1124. In the means of transportation 1125, the user may select a public transportation 1126 or private transportation such as his/her own car 1127. The culture exploration travel 1121 may refer to a tourist site-oriented travel, the gourmet travel 1122 may refer to a popular restaurant (for example, recommended restaurant)-oriented travel, the activity travel 1123 may refer to a travel experienced through a body or a baby/child-oriented travel, and the filial travel 1124 may refer to a travel for relaxation or a parent-oriented travel. The user may select the travel category or the means of transportation 1125 in the user interface screen 1120.

In addition, although not illustrated, the user interface screen 1120 may include an option item for selecting a current location, current time, or biometric information-oriented travel. Moreover, although not illustrated, the travel category may further include various categories such as a shopping travel and a relaxation travel. Furthermore, although not illustrated, the means of transportation 1125 may further include various means of transportation such as a bicycle, a motorcycle, and by walk.

FIG. 11C illustrates changed itineraries when the gourmet travel 1122 and the own car 1127 are selected in the user interface screen 1120. Referring to FIG. 11C, the controller 512 may display a user interface screen 1130 including itineraries changed to fit the option items in the basic itineraries of FIG. 11A. The user interface screen 1130 may display a map image on which the accommodation 1101, Land Mark2 1102, the restaurant of Land Mark3 1103, and another restaurant of Land Mark5 1105 are marked at corresponding locations. Based on a comparison between the basic itineraries (the user interface screen 1110) and the changed itineraries (the user interface screen 1130), another restaurant of Land Mark5 1105 may be included in the changed itineraries instead of the tourist site of Land Mark4 1104 illustrated in FIG. 11A. The controller 512 may insert the other restaurant instead of the tourist site to comply with the gourmet travel 1122 because the user has changed the travel category into the gourmet travel 1122.

FIG. 11D illustrates an example for changing the basic itineraries according to a user's input. Referring to FIG. 11D, the controller 512 may display basic itineraries including all of tourist sites and restaurants Which the user can visit from the accommodation 1101. A user interface screen 1140 may display a map image on which the accommodation 1101, Land Mark2 1102, the restaurant of Land Mark3 1103, the tourist site of Land Mark4 1104, the other restaurant of Land Mark5 1105, a recommended restaurant of Land Mark6 1106, and a restaurant of Land Mark7 1107 are marked at corresponding locations. At this time, the controller 512 may also display option items for adding and deleting the tourist sites and the restaurants displayed in the basic itineraries. The controller 512 may change the basic itineraries according to the option item selected by the user.

For example, the user may add or delete the restaurant of Land Mark3 1103 in the basic itineraries by selecting addition 1103a or deletion 1103b marked beside the restaurant of Land Mark3 1103. For example, the user may add or delete a tourist site of Land Mark4 1104 to or from the basic itineraries by selecting addition 1104a or deletion 1104b marked beside the tourist site of Land Mark4 1104. The user may add or delete the other restaurant of Land Mark5 1105 in the basic itineraries by selecting addition 1105a or deletion 1105b marked beside the other restaurant of Land Mark5 1105. The user may add or delete a recommended restaurant of Land Mark6 1106 in the basic itineraries by selecting addition 1106a or deletion 1106b marked beside the recommended restaurant of Land Mark6 1106. The user may add or delete a restaurant of Land Mark7 1107 in the basic itineraries by selecting addition 1107a or deletion 1107b marked beside the restaurant of Land Mark7 1107.

Although not illustrated, when the user pushes an object out of the screen (for example, a display area of the display 160) on the user interface screen (for example, reference numeral 1110, 1130, or 1140) in which objects (for example, the accommodation 1101, Land Mark2 1102, the restaurant of Land Mark3 1103, and the tourist site of Land Mark4 1104) are marked on the map image, the corresponding object may be deleted from the basic itineraries. Alternatively, when the user makes a long press touch on the object in the user interface screen 1140, the controller 512 may also display option items for adding and deleting the tourist sites and the restaurants displayed in the basic itineraries. The long press touch may correspond to an input distinguished from a tap touch corresponding to a short touch and refer to a touch which is made for a longer time than the tap touch. The option items may be “+” and “−” as illustrated in FIG. 11D or “×” marked at the object. When “×” is marked at the object and the user selects “×”, the object at which “×” is marked may be deleted. For example, when the user selects (or touches) “×” marked at the restaurant of Land Mark3 1103, the restaurant of Land Mark3 1103 may be deleted from the basic itineraries.

FIG. 11E illustrates an example for selecting an option item in the user interface screen 1120. Referring to FIG. 11E, the controller 512 may receive a selection of the culture exploration travel 1121 and the public transportation 1126 as the means of transportation 1125 from the user on the user interface screen 1120.

FIG. 11F illustrates changed itineraries when the culture exploration travel 1121 and the public transportation 1126 are selected in the user interface screen 1120 of FIG. 11E. Referring to FIG. 11F, the controller 512 may display a user interface screen 1150 including itineraries changed to fit the option items in the basic itineraries of FIG. 11A. The user interface screen 1150 may display a map image on which the accommodation 1101, Land Mark2 1102, a museum of Land Mark5 1151, and a gallery of Land Mark6 1152 are marked at corresponding locations. Based on a comparison between the basic itineraries (the user interface screen 1110) and the changed itineraries (the user interface screen 1150), the museum of Land Mark5 1151 and the gallery of Land Mark6 1152 may be included in the changed itineraries instead of the restaurant of Land Mark3 1103 and the tourist site of Land Mark4 1104. Since the user changes the travel category into the culture exploration travel 1121 and the means of transportation 1125 into the public transportation 1126, the controller 512 may further insert the other tourist site to comply with the culture exploration travel 1121 instead of the restaurant. Further, when selecting a tourist site, the controller 512 may preferentially select a tourist site which the user can easily visit through the public transportation 1126.

FIG. 11G illustrates another example for selecting the option item in the user interface screen 1120. Referring to FIG. 11G, the controller 512 may receive a selection of the activity travel 1123 and the own car 1127 as the means of transportation 1125 from the user on the user interface screen 1120.

FIG. 11H illustrates changed itineraries when the activity travel 1123 and the own car 1127 are selected in the user interface screen 1120. Referring to FIG. 11H, the controller 512 may display a user interface screen 1160 including itineraries changed to fit the option items in the basic itineraries of FIG. 11A. The user interface screen 1160 may display a map image on which the accommodation 1101, Land Mark2 1102, Lotte World of Land Mark5 1161, and Seoul land of Land Mark6 1162 are marked at corresponding locations. Based on a comparison between the basic itineraries (the user interface screen 1110) and the changed itineraries (the user interface screen 1160), Lotte World of Land Mark5 1161 and Seoul land of Land Mark6 1162 may be included in the changed itineraries instead of the restaurant of Land Mark3 1103 and the tourist site of Land Mark4 1104. Since the user changes the travel category into the activity travel 112.3 and the means of transportation 1125 into the own car 1127, the controller 512 may further insert the activity tourist sites to comply with the activity travel 1123 instead of the restaurant. Further, when selecting a tourist site, the controller 512 may preferentially select a tourist site which the user cannot visit easily through the public transportation 1126 but can easily visit through the own car 1127.

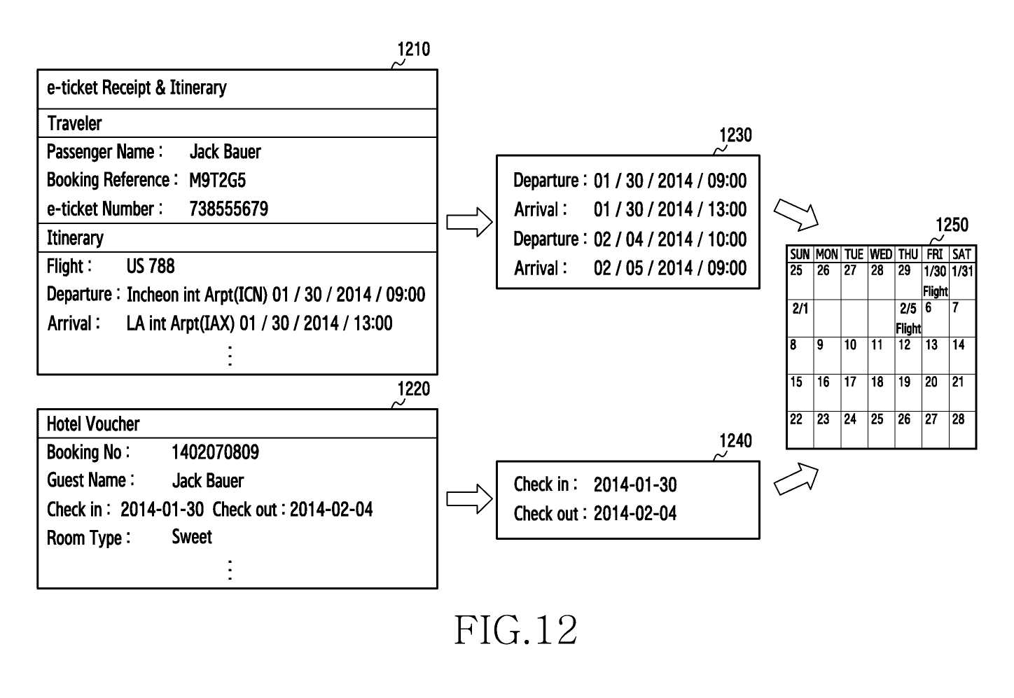

FIG. 12 illustrates an example for generating basic itineraries according to various embodiments of the present disclosure.

Referring to FIG. 12, the controller 512 may extract airport arrival date and time/departure date and time 1230 from flight information 1210. Further, the controller 512 may extract check-in/check-out date and time 1240 from accommodation information 1220. The controller 512 may transmit the airport arrival date and time/departure date and time 1230 and the check-in/check-out date and time 1240 to the travel itinerary provision server 550. The controller 512 may receive basic itineraries 1250 from the travel itinerary provision server 550. The basic itineraries 1250 may be provided in a calendar form, and when the user selects a date, the controller 512 may provide one or more basic itineraries corresponding to the date.

According to various embodiments of the present disclosure, the controller 512 may extract the flight information 1210 and the accommodation information 1220 from a message, travel, accommodation-related application. The controller 512 may transmit the flight information 1210 and the accommodation information 1220 to the travel itinerary provision server 550. The travel itinerary provision server 550 may extract the airport arrival date and time/departure date and time 1230 from the flight information 1210 and extract the check-in/check-out date and time 1240 from the accommodation information 1220. The travel itinerary provision server 550 may generate the basic itineraries 1250 based on the airport arrival date and time/departure date and time 1230, the check-in/check-out date and time 1240, user information of the electronic device 510, and situation information. The travel itinerary provision server 550 may transmit the basic itineraries 1250 to the electronic device 510.

The computer readable recoding medium may include a hard disk, a floppy disk, magnetic media (e.g., a magnetic tape), optical media (e.g., a compact disc ROM (CD-ROM) and a DVD), magneto-optical media (e.g., a floptical disk), a hardware device (e.g., a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
receiving at least one piece of first itinerary information generated by an external device based on first situation information;
acquiring second itinerary information for changing at least a part of the first itinerary information based on at least one of a user and second situation information; and
providing the second itinerary information to the user.

2. The method of claim 1, wherein the first situation information includes at least one of user information, flight information, traffic reservation information, accommodation information, life log information, or any combination thereof.

3. The method of claim 1, wherein the receiving of the at least one piece of first itinerary information comprises:
receiving the first itinerary information generated through the external device based on at least one piece of travel information, location information, date information, traffic situation information, weather information, or any combination thereof.

4. The method of claim 1, wherein the acquiring of the second itinerary information comprises:
comparing the first itinerary information with the second situation information; and
generating the second itinerary information based on a result of the comparison.

5. The method of claim 1, further comprising at least one of:
collecting the second situation information by using a sensor module included in the electronic device; or
receiving the second situation information from the external device.

6. The method of claim 1, wherein the second itinerary information includes itinerary information generated by adding, deleting, or changing at least one of a travel destination, traffic, restaurant, and route included in the first itinerary information.

7. The method of claim 1, further comprising:
making a request for the second situation information to the external device according to a request of the user, and
setting information of the electronic device, in real time, or periodically.

8. The method of claim 1, further comprising:
determining whether an itinerary is completed; and
when the itinerary is not completed, repeatedly acquiring the second itinerary information and providing the second itinerary information to the user.

9. An electronic device comprising:
a communication interface;
a memory; and
a processor electrically connected to the memory,wherein the processor is configured to:
transmit information to an external device,
receive first itinerary information based on the information from the external device,
change at least a part of the first itinerary information based on the first situation information to generate second itinerary information, and
provide the second itinerary information.

10. The electronic device of claim 9, further comprising:
an interface;
wherein the processor is further configured to receive the information from a user through the interface or to extract the information from an application.

11. The electronic device of claim 9, wherein the information includes at least one of a flight, accommodation, user information, preferred travel destination, preferred itinerary, travel category, or any combination thereof.

12. The electronic device of claim 9, wherein the processor is configured to:
change the first itinerary information according to a request of a user, and
register the changed first itinerary information.

13. The electronic device of claim 9, further comprising:
a sensor;
wherein the processor is further configured to collect first situation information by using the sensor or to receive second situation information from the external device.

14. The electronic device of claim 13, wherein the processor is further configured to:
adjust a time point when second situation information is received, based on whether a communication fee occurs, and
set information of the electronic device.

15. The electronic device of claim 13,
wherein the first situation information includes at least one of a time, location, temperature, humidity, biometric information, or any combination thereof, and
wherein the second situation information includes at least one of traffic, weather, disaster, travel destination-related information, or any combination thereof.

16. The electronic device of claim 9, wherein the processor is further configured to:
compare the first itinerary information with situation information,
determine whether a change to an itinerary is required, based on a result of the comparison, and
generate the second itinerary information according to a result of the determination.

17. The electronic device of claim 9, wherein the processor is further configured to:
make a request for the second situation information to the external device according to a request of a user, and
set information of the electronic device, in real time, or periodically.

18. A server comprising:
a transceiver;
a memory, and
a processor,
wherein the processor is configured to:
receive information from an electronic device,
collect situation information,
generate first itinerary information based on the information and the situation information,
transmit the generated first itinerary information to the electronic device, and, when the situation information is updated, and
transmit the updated situation information to the electronic device.
